(19) United States
(12) Patent Application Publication
(10) Pub. No.: US 2020/0247558 A1
(43) Pub. Date: Aug. 6, 2020

(54) AUXILIARY SYSTEM FOR TAKE-OFF, LANDING, AND CARRYING OF MULTI-ROTOR UNMANNED AIRCRAFT ON MOBILE PLATFORM

(71) Applicant: NANJING UNIVERSITY OF AERONAUTICS AND ASTRONAUTICS, NANJING (CN)

(72) Inventors: XIANGRUI TIAN, NANJING (CN); JIAMENG ZHOU, NANJING (CN); XIAODONG WAN, NANJING (CN)

(21) Appl. No.: 16/745,443

(22) Filed: Jan. 17, 2020

(30) Foreign Application Priority Data
Feb. 2, 2019 (CN) 201910106091.X

(51) Int. Cl. B64F 1/00; B64C 39/02

(52) U.S. Cl. CPC B64F 1/007; B64C 39/024; B64C 2201/18; B64C 2201/208; B64C 2201/088

(57) ABSTRACT

Some embodiments provide an auxiliary system for take-off, landing, and carrying of a multi-rotor unmanned aircraft on a mobile platform. One system includes a base and a sleeve rod. The base is fixed on the mobile platform. The sleeve rod is inserted into an opening of the base and fixed on the mobile platform. An airframe is provided with a circular hole at a center portion, through which the sleeve rod is configured to pass. The cone sleeve on the lower side has a circular opening at a top portion fixedly connected to the circular hole. The cone sleeve on the upper side has a circular opening at a top portion. A sleeve is provided downward along the circular opening.

### CROSS REFERENCE TO RELATED APPLICATIONS

This application claims priority to Chinese application number 20191010609-1.X, filed on Feb. 2, 2019, the disclosure of which is incorporated by reference herein in its entirety.

### FIELD OF THE DISCLOSURE

The disclosure relates generally to the field of a system for autonomous take-off and landing of an unmanned aircraft. More specifically, the disclosure relates to a system for autonomous take-off, landing, and carrying of a multi-rotor unmanned aircraft based on a mobile platform.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides an auxiliary system for take-off, landing, and carrying of a multi-rotor unmanned aircraft on a mobile platform. The system includes a base and a sleeve rod provided on the mobile platform. The system further includes two cone sleeves and a sleeve provided on the multi-rotor unmanned aircraft. The base is conical and fixed on the mobile platform, and the base has an opening at a top portion. A bottom end of the sleeve rod is inserted into the opening at the top portion of the base and fixed on the mobile platform. The sleeve rod is a vertical rod with a smooth surface. An airframe of the multi-rotor unmanned aircraft is provided with a circular hole at a center portion, through which the sleeve rod is configured to pass. The two cone sleeves are disposed on an upper side and a lower side of the airframe respectively. Outer dimensions of the two cone sleeves are consistent with outer dimensions of the base. The cone sleeve on the lower side of the airframe has a first circular opening at a top portion, and the first circular opening being fixedly connected to the circular hole of the airframe. The cone sleeve on the upper side of the airframe has a second circular opening at a top portion. And the sleeve is provided downward along the second circular opening. A bottom end of the sleeve is fixedly connected to the circular hole of the airframe, and communicates with the cone sleeve on the lower side of the airframe.

In other embodiments, the disclosure provides an auxiliary system for take-off, landing, and carrying of a multi-rotor unmanned aircraft on a mobile platform. The system includes a base and a sleeve rod provided on the mobile platform, and two cone sleeves and a sleeve provided on the multi-rotor unmanned aircraft. The base is conical with an opening at the top. The base is fixed on the mobile platform. The bottom end of the sleeve rod is inserted into the opening at the top of the base and fixed on the mobile platform. The sleeve rod is a vertical and long rod with a smooth surface. An airframe of the multi-rotor unmanned aircraft is provided with a circular hole at the center thereof, through which the sleeve rod is configured to pass. The two cone sleeves are disposed on the upper side and lower side of the airframe respectively. The outer dimensions of the cone sleeves are consistent with those of the base. The cone sleeve on the lower side of the airframe has a circular opening at the top fixedly connected to the circular hole. The cone sleeve on the upper side of the airframe also has a circular opening at the top thereof. A hollow cylindrical sleeve is provided downward along the circular opening. The bottom end of the sleeve is fixedly connected to the circular hole in the center of the airframe, and communicates with the cone sleeve on the lower side of the airframe.

Optionally, a top end of the sleeve rod is smooth and spherical.

Optionally, the space formed by the outer side of the cone sleeve on the lower side of the airframe and the lower side of the airframe accommodates an airborne equipment of the multi-rotor unmanned aircraft.

Optionally, the space formed by the inner side of the cone sleeve on the upper side of the airframe and the outer side of the sleeve accommodates an airborne equipment of the multi-rotor unmanned aircraft.

Optionally, the two cone sleeves on the upper side and the lower side of the airframe of the multi-rotor unmanned aircraft are made of rigid non-metallic materials.

### BRIEF DESCRIPTION OF THE DRAWINGS

Illustrative embodiments of the disclosure are described in detail below with reference to the attached drawing figures.

FIG. 1 shows a schematic diagram of a moving platform with a base and a sleeve rod according to an embodiment of the disclosure.

FIG. 2 shows a schematic view of two cone sleeves, a sleeve, and a multi-rotor unmanned aircraft according to an embodiment of the disclosure.

FIG. 3 shows a schematic diagram of stacking multi-rotor unmanned aircrafts over a sleeve rod of a moving platform according to an embodiment of the disclosure.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

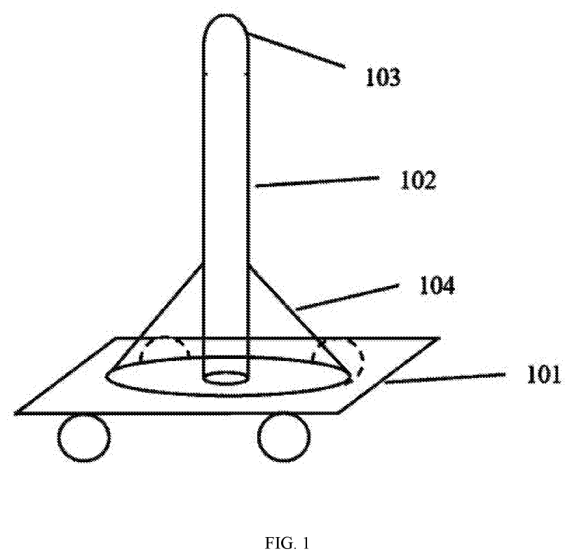

FIGS. 1-3 show some embodiments of an auxiliary system for take-off, landing, and carrying of a multi-rotor unmanned aircraft on a mobile platform. The system may include a base 104 and a sleeve rod 102 provided on a mobile platform 101, and the system may further include cone sleeves 203 and 204 and a sleeve 205 provided on a multi-rotor unmanned aircraft 201.

As shown in FIG. 1, the base 104 is conical with an opening at the top, which has a truncated cone shape as a whole. The base 104 is fixed on the mobile platform 101 to enhance the stability of the sleeve rod 102 on the one hand and to carry the multi-rotor unmanned aircraft 201 at the bottommost end on the sleeve rod 102 on the other hand. The bottom end of the sleeve rod 102 is inserted into the opening at the top of the base 104 and fixed on the mobile platform 101. The sleeve rod 102 is a vertical, long rod with a smooth surface to ensure that the friction between a sleeve and the sleeve rod 102 is small when the multi-rotor unmanned aircraft 201 takes off and lands. The multi-rotor unmanned aircraft 201 may smoothly take off and land even if there is contact between the multi-rotor unmanned aircraft 201 and the sleeve rod 102. The top end 103 of the sleeve rod 102 is smooth and spherical to ensure that when it contacts the cone sleeve 203 on the lower side of the multi-rotor unmanned aircraft 201, it may slide into the sleeve 205 with a small frictional resistance. The length of the sleeve rod 102 is determined according to the height of the multi-rotor unmanned aircraft 201 and the number of multi-rotor unmanned aircraft 201 to be stored on the sleeve rod 102. If there is sufficient space, multiple sleeve rods 102 may be installed on one mobile platform 101 to increase the number of multi-rotor unmanned aircrafts 201 carried on the mobile platform 101.

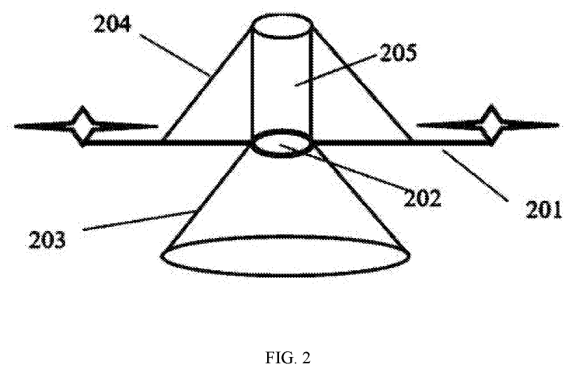

As shown in FIG. 2, firstly, a circular hole 202 is opened in the center of an airframe of the multi-rotor unmanned aircraft 201, and the diameter of the circular hole 202 may be designed to be slightly larger than the diameter of the sleeve rod 102. Cone sleeves 204 and 203 are disposed on the upper side and the lower side of the airframe respectively. The outer dimensions of the cone sleeves 204 and 203 are consistent with the outer dimensions of the base 104. The cone sleeve 203 on the lower side of the airframe has a circular opening at the top and is fixedly connected to the circular hole 202; and the cone sleeve 204 on the upper side of the airframe also has a circular opening at the top. A hollow cylindrical sleeve 205 is provided downward along the circular openings of the cone sleeves 203 and 204. The bottom end of the sleeve 205 is fixedly connected to the circular hole 202 in the center of the airframe, and the bottom end further communicates with the cone sleeve 203. There is clear space inside the sleeve 205 and inside the cone sleeve 203. The diameter of the sleeve 205 is slightly larger than the diameter of the sleeve rod 102 to ensure that the sleeve rod 102 may be put in the sleeve 205. An airborne equipment of the multi-rotor unmanned aircraft 201 may be placed in the space formed by the outer side of the cone sleeve 203 and the lower side of the airframe, or it may be placed in the space formed by the inside of the cone sleeve 204 and the outer side of the sleeve 205. In order to ensure the stable transmission of electronic signals, the cone sleeves 203 and 204 are made of rigid non-metallic materials with smooth surfaces.

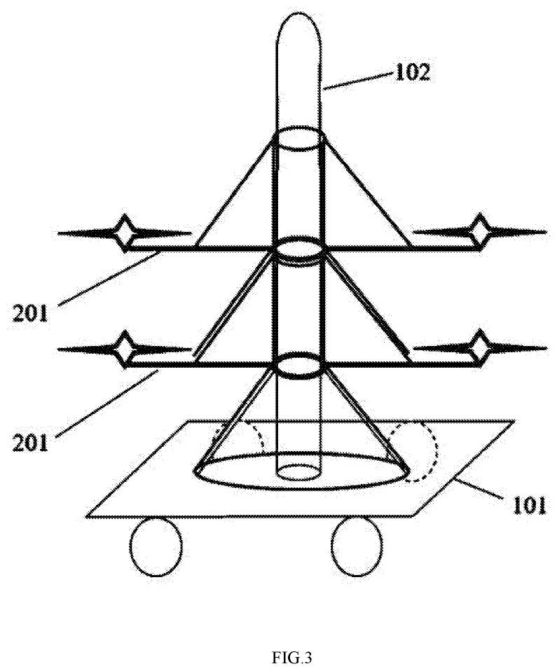

As shown in FIG. 3, the multi-rotor unmanned aircrafts 201 are carried on the mobile platform 101 in such a way that two multi-rotor unmanned aircrafts 201 are stacked together and the sleeve rod 102 of the mobile platform 101 is enclosed by each of the multi-rotor unmanned aircrafts 201. Multi-rotor unmanned aircrafts 201 may be stacked up and down because cone sleeves 203 and 204 are respectively disposed on the upper side and the lower side of each multi-rotor unmanned aircraft 201 which have the same outer dimension from the top to the bottom. Therefore, multiple multi-rotor unmanned aircrafts 201 may be stacked on one sleeve rod 205. When the multi-rotor unmanned aircrafts 201 need to take off, the top-most multi-rotor unmanned aircraft generates the lift force from the rotor and rises along the sleeve rod 205. Since the surfaces of the sleeve and the sleeve rod are smooth, even if there is a little contact between the surfaces, it will not affect the take-off of the multi-rotor unmanned aircraft 201. The multi-rotor unmanned aircraft 201 may fly according to a set path when it lifts off the sleeve rod 205. When the multi-rotor unmanned aircraft 201 needs to land, it first flies to the top of the sleeve rod 205, and then gradually drops. The sleeve rod 205 is ensured to enter the cone sleeve 203 on the lower side of the multi-rotor unmanned aircraft 201 with the help of one or more photoelectric sensing devices. Even if the sleeve 205 in the middle of the multi-rotor unmanned aircraft 201 is not aligned with the sleeve rod 102 on the mobile platform 101, as the multi-rotor unmanned aircraft 201 drops and lands, the top end 103 of the sleeve rod 102 contacts the cone sleeve 203 on the lower side, and causes the multi-rotor unmanned aircraft 201 to slide laterally to some extent, thus allowing the sleeve rod 102 to enter the sleeve 205. When the sleeve 205 of the multi-rotor unmanned aircraft 201 encloses the sleeve rod 102, the aircraft may descend quickly. If there is no other aircraft at the bottom of the sleeve rod 102, the multi-rotor unmanned aircraft 201 will land directly on the conical base 104 on the mobile platform 101. If there is another aircraft at the bottom of the sleeve rod 102, the cone sleeve 203 on the lower side of a landing multi-rotor unmanned aircraft 201 is then nested on the cone sleeve 204 on the upper side of another lower aircraft 201.

Various embodiments of the disclosure may have one or more of the following effects. The disclosure may provide an auxiliary system for take-off, landing, and carrying of a multi-rotor unmanned aircraft on a mobile platform, which may help to complete tasks such as autonomous take-off, landing, storage, carrying, et cetera of the multi-rotor unmanned aircraft on the mobile platform. The disclosure may further achieve the autonomous take-off, landing, storage, and carrying of the multi-rotor unmanned aircraft on the ground mobile platform through the designs of the multi-rotor unmanned aircraft and the mobile platform, which may help to achieve autonomous collaboration of the on-board unmanned aircraft and the multi-UAV platform.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. An auxiliary system for take-off, landing, and carrying of a multi-rotor unmanned aircraft on a mobile platform, comprising:
a base and a sleeve rod provided on the mobile platform; and
two cone sleeves and a sleeve provided on the multi-rotor unmanned aircraft;
wherein:
the base is conical and fixed on the mobile platform, the base having an opening at a top portion;
a bottom end of the sleeve rod is inserted into the opening at the top portion of the base and fixed on the mobile platform, the sleeve rod being a vertical rod with a smooth surface;
an airframe of the multi-rotor unmanned aircraft is provided with a circular hole at a center portion, through which the sleeve rod is configured to pass;
the two cone sleeves are respectively disposed on an upper side and a lower side of the airframe;
outer dimensions of the two cone sleeves are consistent with outer dimensions of the base;
the cone sleeve on the lower side of the airframe has a first circular opening at a top portion, the first circular opening being fixedly connected to the circular hole of the airframe;
the cone sleeve on the upper side of the airframe has a second circular opening at a top portion, along which the sleeve is provided downward; and
a bottom end of the sleeve is fixedly connected to the circular hole of the airframe, and communicates with the cone sleeve on the lower side of the airframe.

2. The system according to claim 1, wherein a top end of the sleeve rod is smooth and spherical.

3. The system according to claim 1, wherein:
a space is formed by an outer side of the cone sleeve on the lower side of the airframe and the lower side of the airframe; and
the space accommodates an airborne equipment of the multi-rotor unmanned aircraft.

4. The system according to claim 1, wherein:
a space is formed by an inside of the cone sleeve on the upper side of the airframe and the outside of the sleeve; and
the space accommodates an airborne equipment of the multi-rotor unmanned aircraft.

5. The system according to claim 1, wherein the two cone sleeves are made of rigid non-metallic material.
